(19) United States
(12) Patent Application Publication
(10) Pub. No.: US 2018/0285892 A1
(43) Pub. Date: Oct. 4, 2018

(54) SENTIMENT AND ANALYTICS FOR PREDICTING FUTURE LEGISLATION

(71) Applicant: International Business Machines Corporation, Armonk, NY (US)

(72) Inventors: Bradford Brooks, Longmont, CO (US); Grant D. Miller, Arvada, CO (US); Srinivas B. Tummalapenta, Broomfield, CO (US); Jason T. Wertz, Pleasant Valley, NY (US); Hamza Yaswi, Erie, CO (US)

(21) Appl. No.: 15/475,484

(22) Filed: Mar. 31, 2017

(51) Int. Cl. G06Q 30/02

(52) U.S. Cl. CPC G06Q 30/0201; G06Q 30/018

(57) ABSTRACT

A system and method to predict future legislation using sentiment and analytics. The method includes capturing analytics based on factors that drive a new piece of legislation such that a voting prediction can be determined. The method applies analytics across a large population of politicians (e.g., Senate, House of Representatives) for predetermining how legislation will pass or fail. The method performs: generating a sentiment score, a sentiment momentum value for a topic; generating a correlation between a new legislation topic and previous associated topics and their outcomes; generating a sentiment score and a sentiment momentum of politicians to vote on the new legislation; generating a correlation between a politician's likely vote on new legislation based on previous voting record for that politician; and using analytics to correlate between sentiment and voting correlations between topics and politicians and predict a potential vote of a politician on a given legislative topic.

### FIELD

This disclosure relates generally to data analytics, and more specifically to tools for sentiment analysis and predictive analytics.

### BACKGROUND

As new regulatory compliance laws are put in place, businesses have to make major changes they may not be expecting. For example, the new laws can force a business to change how they produce goods or the materials/processes they use to produce goods. Those unforeseen changes can cost a business manufacturing delays, added cost in production, and in some cases re-invent their products. For example, if a new law bans the use and import (or increases import taxes) of a specific material used to manufacture a device, the business will not only need to find a replacement, but will also need to ensure that the replacement meets all their needs, is acceptable by law, and is comparable from a cost and quality perspective.

### SUMMARY

The present invention provides a method, computer-implemented system, and computer program product that analyses and assesses public and legislative sentiment and predicts new laws/regulations in advance based on that public and legislative sentiment. The method includes determining, at a processing unit, a public sentiment associated with a current topic of public discourse and generating an associated public momentum score; determining, at the processing unit, any new law or new legislation pending enactment in a legislative body that relates to the current topic, a law or legislation having provisions determined to change an operation of an entity; identifying, at the processing unit, each legislator to vote on the new law or new legislation pending enactment; determining, at the processing unit, for each identified legislator, a sentiment and a legislator sentiment momentum score of the current topic; obtaining data representing a legislator's voting history relating to one or more previous legislations relating to the current topic; determining, at the processing unit, for each identified legislator, a probability measure indicating that likely legislator's vote on the new law or new legislation using that legislator's sentiment momentum score, and that legislator's voting history relating to the one or more previous legislations and the public sentiment momentum score; determining, at the hardware processing unit, a probability of enactment of the new law or new legislation based on determined probability measures; and generating, by the processing unit, an output signal to notify an entity of the probability of enactment.

Other embodiments of the present invention include a computer-implemented system and a computer program product which implement the above-mentioned method.

### BRIEF DESCRIPTION OF THE DRAWINGS

These and other objects, features and advantages of the present invention will become apparent from the following detailed description of illustrative embodiments thereof, which is to be read in connection with the accompanying drawings, in which:

FIG. 1A depicts a computer system implementing analytics to predict a future enactment of a regulation or law in one embodiment;

FIG. 1B shows an alternate embodiment of the system implementing analytics to predict a future enactment of a regulation or law;

FIG. 2 shows processing methods for determining a topic sentiment and sentiment momentum in one embodiment;

FIG. 3 depicts a further block diagram depicting the processing of the topic analytics block of FIGS. 1A and 1B for mapping a current or past legislation(s) to a current topic in one embodiment;

FIG. 4 shows processing methods for determining a politician's sentiment relating to a topic in one embodiment;

FIG. 5 depicts the various inputs to voting analytics processing block used in predicting a likelihood that a particular piece of legislation to be voted upon by legislators will pass;

FIG. 6 depicts a processing method employed by the computing system of FIGS. 1A, 1B; and

FIG. 7 is an exemplary block diagram of a computer system in which processes involved in the system, method, and computer program product described herein may be implemented.

### DETAILED DESCRIPTION

There are many factors that can cause a government of a country, state, or municipality to pass a law. The factors range from public opinion, geopolitical situation, environmental factors, and foreign government's reactions to an issue. There can also be a single factor that completely overrides the current public opinion and negates all factors affecting the creation of a law. When taken into account with additional factors like GDP, foreign relations, voting records, and lobbyists, predicting new laws in advance, with defined certainty, so a business can start a transformation process before the law is implemented is made even more complex.

In one embodiment, the system and methods of the present invention recognize that, for a legislator (e.g., also referred to herein as “politician”), there are three main driving forces in predicting the legislator's vote on certain subjects. These driving forces include, but are not limited to: 1) the topic that is being discussed; 2) the legislator's personal opinion based on previous accounts, and 3) the legislator's current views. Other examples of driving forces in predicting a legislator's vote may include that legislator's donation history, business portfolio, etc. For each of these driving forces, information is collected based on where the source is being driven from. For topic sources, these can be from newspapers, local and social media, blogs, etc. For the politician's personal opinion, these would be from local and social media, websites, newspapers, speeches, politician's office statements, etc. For the politician current views, the driving forces are speeches given in Congress/parliament/town-hall, interviews, party affiliations, etc.

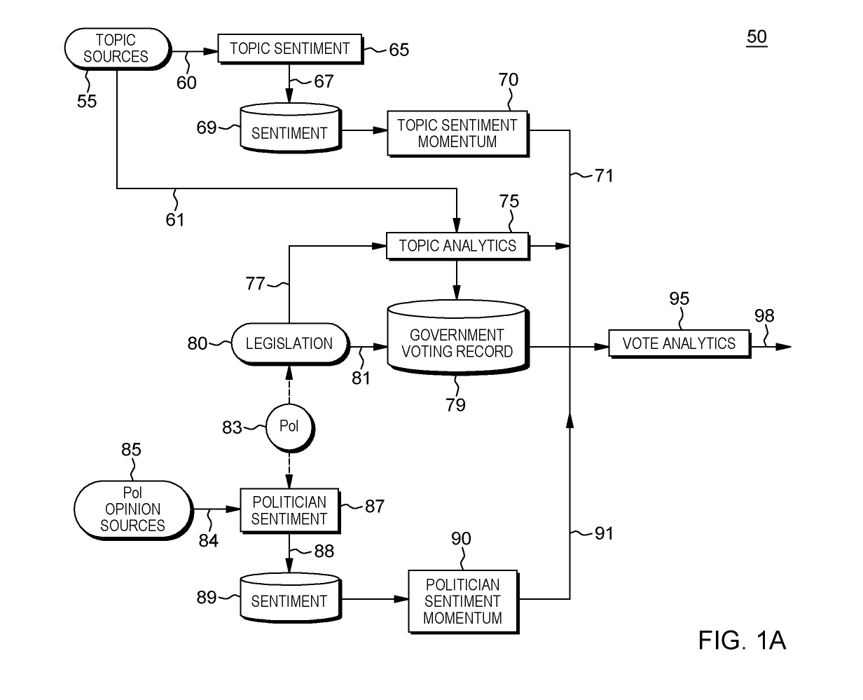

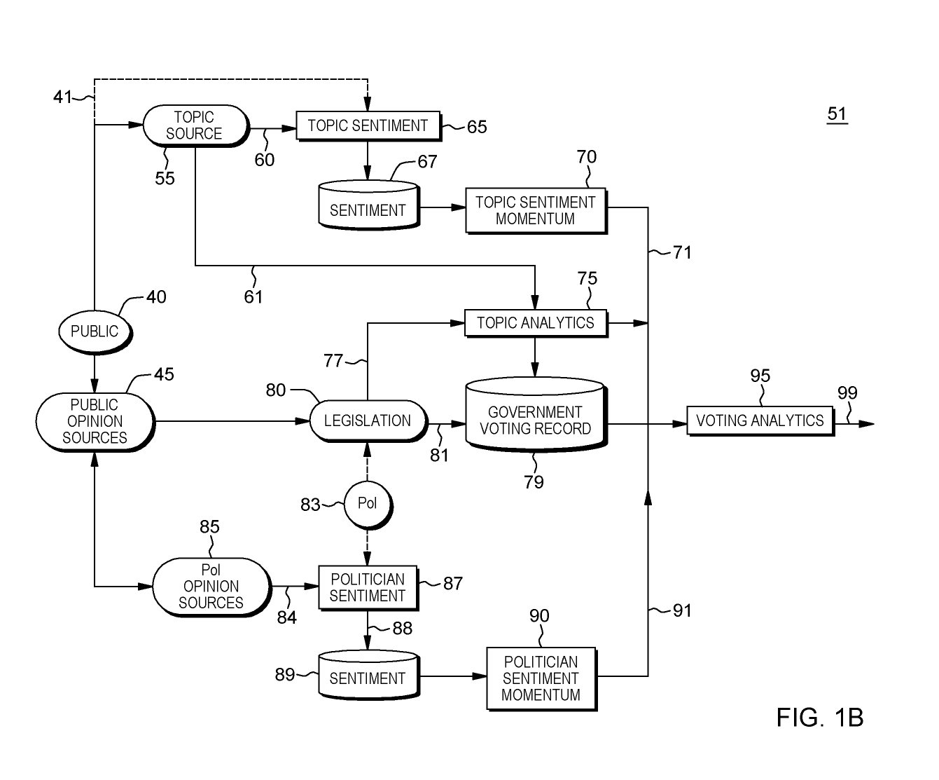

In the computer system embodiment of FIG. 1A and alternate embodiment of FIG. 1B, methods are invoked to analyze each of these three driving forces using analytics to determine a certain topic sentiment, and the politician's associated sentiment towards a topic based on the politician's current views and prior personal opinions. As referred to herein, a “sentiment” refers to an emotion behind a topic, e.g., a social media mention, and is a way to measure the “tone” of particular statements or conversations, e.g., is the person/public happy, annoyed, angry?

These sentiments are tracked in real time or can be used to create a historic data record for analyzing against current topics of interest. Once the topic sentiments and a politician's sentiment are determined, analytics are employed to shape how different topics and the politician's views align to determine which way a legislator (the politician) will vote, and ultimately, which laws/regulations will be enacted. An entity may thus be immediately informed of any changes of legislation, determine its impact on the entity, and trigger a transformation of a business operation in anticipation of its enactment.

FIG. 1A depicts a block diagram of a computer-implemented system 50 implementing methods to predict a future enactment of a law or regulation. In one embodiment, the system 50 processes information and data representing the several driving forces for use in predicting a politician's vote on certain subjects. Using a vote analytics processing block 95, the system generates an output 98 indicating a probability of politician's likelihood of a vote on a particular piece of legislation, e.g., legislation or regulation currently under consideration by a legislative body at any level of government. In one embodiment, the vote analytics processing block 95 is invoked to generate a probabilistic outcome of a vote (e.g., enactment or fail) of a single piece of legislation based on an aggregate of all politicians vote probabilities.

As shown, the computing system 50 receives, e.g., via a network interface or a memory storage location, a data input indicating a particular topic 60 from a particular public domain source. In one embodiment, a topic 60 may be obtained from one or more topic sources 55, e.g., a web-site, a web blog, a social media site such as Facebook®, Twitter®, an electronic news feed, a newspaper, transcripts of a “town hall” meeting, etc. In one aspect, topic sources may be available via the Internet. In one aspect, a topic may be sourced from “dark data” which is defined as operational data that is not being used, e.g., topics relating to information assets that organizations collect, process, and store in the course of their regular business activity, but generally fail to use for other purposes.

In view of FIG. 1A, for a particular topic 60 that drives legislation, e.g., second amendment rights, environment, etc., there is invoked a first analysis block 65 configured for obtaining and/or generating a topic sentiment score and a topic sentiment momentum on that topic. The method includes determining a particular topic sentiment 67, i.e., a sentiment of a topic that may currently be in the public/political discourse. This topic sentiment 67 is indicative of the popularity of the topic and reflects a current sentiment of the public at large (i.e., including the constituents of one or more politicians) as determined by topic sentiment block 65. For example, this topic sentiment may be represented in the form of a score or number value, e.g., high, medium, low values, or positive or negative, relating to the public's shared emotion. Any well-known or future approaches for conducting sentiment analysis may be used to obtain this score or value (e.g., see “Improving Twitter Sentiment Analysis with Topic-Based Mixture Modeling and Semi-Supervised Training” http://www.aclweb.org/anthology/P14-2071 as an example approach.) The currently determined topic sentiments 67 are stored in a memory storage device, e.g., database 69, or a like data storage device configured for storing the corresponding particular topics and related sentiments.

Alternatively, or in addition, to the computer-system processing 50 depicted in FIG. 1A, further functionality is shown in the corresponding system 51 of FIG. 1B, showing how a new topic 41 or legislation 80 may be derived, i.e., in the first instance, from a legislator's (or politician's) raw statements from politician opinion sources 85, or alternatively from public opinion sources 45, or from the public in general 40.

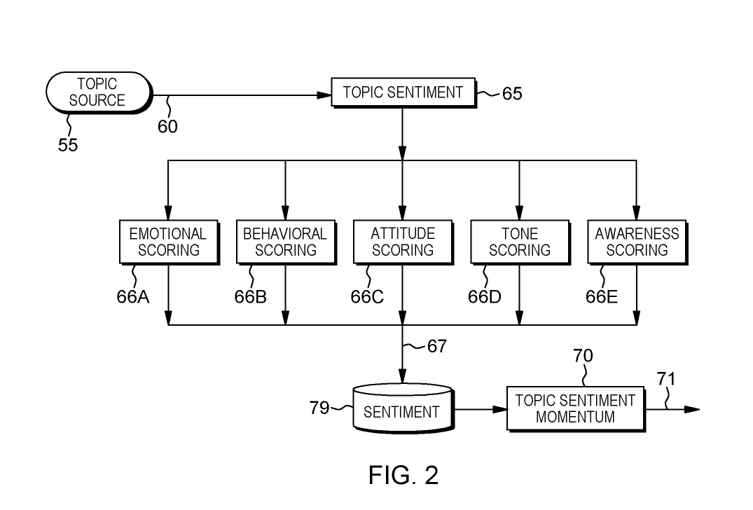

FIG. 2 shows processing methods for determining a topic sentiment at processing block 65. As shown in FIG. 2, based on a method current topic 60 from a topic source 55, topic sentiment analysis block 65 generates a score based on a respective sentiment attribute or criteria. For example, a topic sentiment may be based on various criteria including, but not limited to: the collective public's emotions, behavior, attitudes, tone, awareness, etc. Processing block 65 implements techniques for parsing publically available articles, opinions, and editorials titles and analyzing all the words contained therein such that groupings can be drawn. Data analytic techniques (e.g., sentiment analysis) are then used to generate a corresponding score for each of these sentiment criteria based on the groupings. Techniques may then be used to determine a net positive, net negative, or corresponding high, medium, or low topic sentiment momentum score 71. This sentiment momentum score may be filtered by a user that determines a range for a particular corresponding value (e.g., low=0−35, medium=36−70, and high=71−100).

In one embodiment, to ascertain a public sentiment regarding a current topic 60, the parsing, analyzing, and grouping processing is run on a multi-parallel question answering computing system (e.g., Watson® and IBM Bluemix® (Trademarks of International Business Machines Corporation) for generating one or more of: a public's emotional score generated at emotional scoring block 66A, a behavioral score generated at behavioral block 66B, a attitude score generated at attitude scoring block 66C, a tone score generated at tone scoring block 66D, and a corresponding awareness score generated at awareness scoring block 66E. Each of these scores are further used to determine if a sentiment score for the topic, e.g., a value (e.g., high, medium, or low), is positive or negative for each topic. This sentiment score may be an overall average score based on a combination of the combined scores from scoring blocks 66A-66E. It is further noted that different blocks may have different weights assigned to them. For example, a user may define behavioral as having a higher weight than the other four scoring factors. The system would then calculate a weighted average for sentiment.

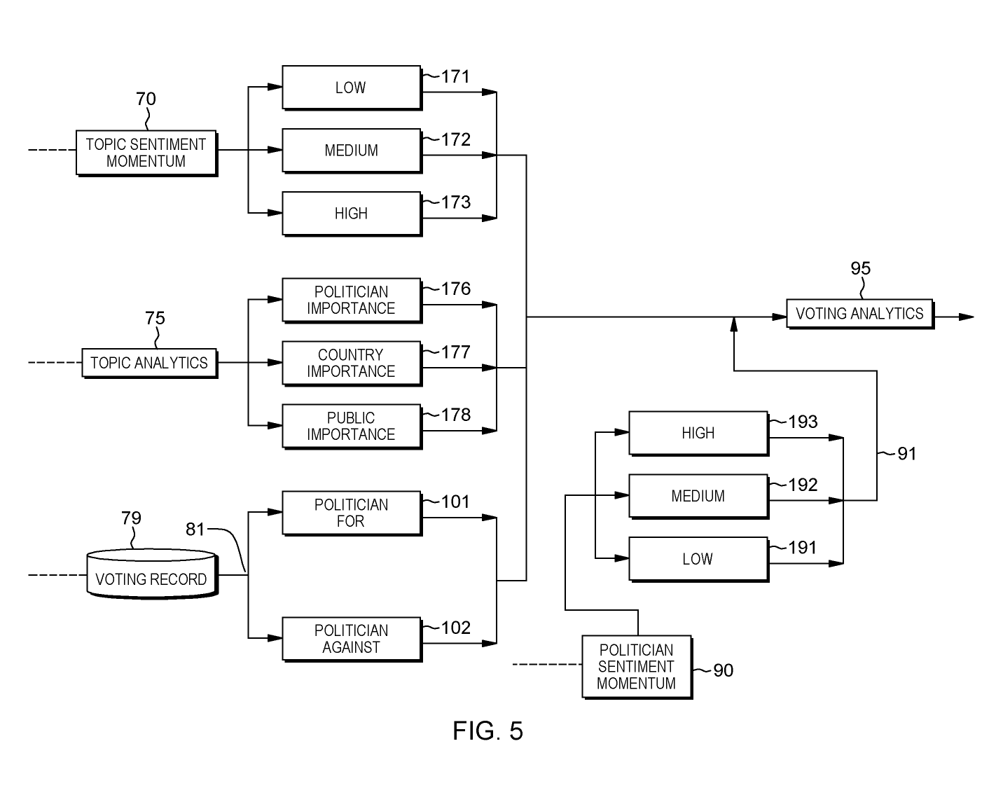

As part of the vote analytics processing, a topic sentiment momentum processing block 70 is invoked at the computing system for determining a topic momentum or “trend”. As referred to herein, “momentum” is a measure of the strength of a topic's sentiment and is computed using a technical analysis tool to determine the likelihood that the sentiment will continue. This is the primary purpose of indicators such as the moving average convergence divergence (MACD), stochastics, and sentiment rate of change (ROC). In one embodiment, topic sentiment momentum block 70 is programmed to ascertain a trend 71, i.e., a measure or score of the popularity of the current topic amongst the public, e.g., in a short period of time, as ascertained using conventional social media sensors and methods. In one embodiment, as shown in FIG. 2, each of the one or more corresponding emotional scores generated at emotional scoring block 66A, behavioral scores generated at behavioral scoring block 66B, attitude scores generated at attitude scoring block 66C, tone score generated at tone scoring block 66D, and awareness score generated at awareness scoring block 66E are accumulated and tallied at the topic sentiment momentum processing block 70 to generate a topic sentiment momentum score, e.g., a low, medium or high momentum value or a positive or negative value. This momentum score may be an average of the combined individual scores from blocks 66A-66E. In one embodiment, as shown in FIG. 5, a topic sentiment momentum score 71 input to vote analytics processing block 95 may be a low value 171, medium value 172 or a high value 173 for use in predicting a likelihood that a particular piece of legislation to be voted upon will pass.

Referring back to the systems shown in FIGS. 1A, 1B, in concurrent processes, there is additionally determined a politician's sentiment 88 about particular topic (or legislation) which can be mapped to a topic sentiment. Based on this determination, the system generates a sentiment score and a sentiment momentum for politicians that vote on a legislation. In one embodiment, a politician sentiment processing block 87 tracks politician opinion sources 85 and extracts information for determining a politician's sentiment 88. In one embodiment, politician's personal opinion sources may include, but are not limited to: local and social media, websites, newspapers, speeches, a politician's office, town hall meetings, and public statements or publications, whether available over the Internet or stored in repositories associated with any public or private entity. In particular, processing block 87 tracks and reviews statements 84 the politician 83 has publically made (e.g., a tweet, a social media blurb, a television interview, or printed interview). From the politician's raw words, using the word parsing, analyzing, and grouping capabilities of the system (e.g., Watson® and IBM Bluemix®), politician sentiment block 87 determines a politician's general sentiment value. Further break down of the politician's public statements at block 87, may lead to determination of favorability, unfavorable, anger, etc. and other (positive or negative) emotions, and this determination is used to create that politician's sentiment value 88 of a specific topic (which may or may not be aligned with that politician's constituents' sentiment for that topic).

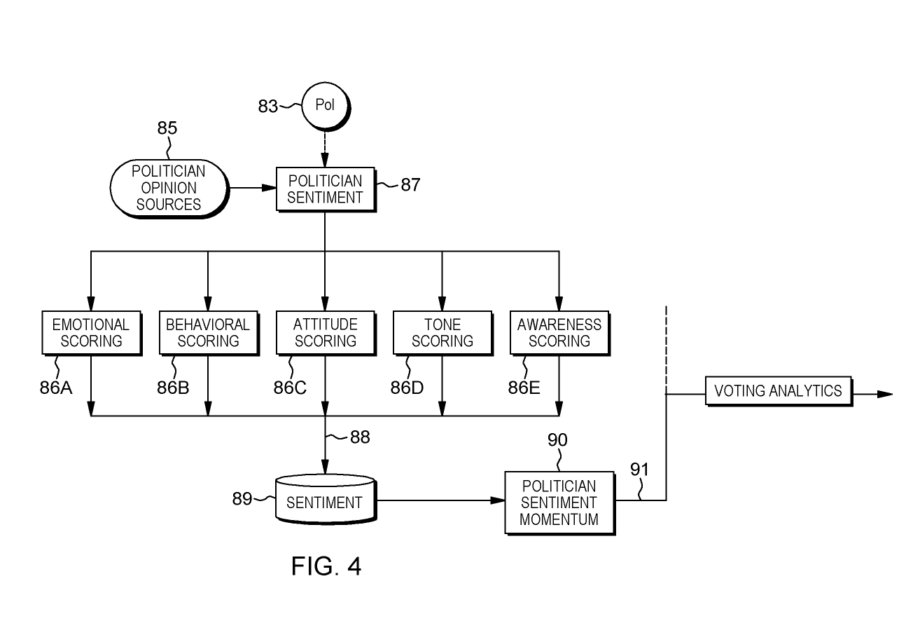

FIG. 4 shows processing methods for determining a politician's sentiment at processing block 87. As shown in FIG. 4, in one embodiment, processing block 87 generates a corresponding score for a variety of sentiment criteria, and determines a net positive or negative sentiment score. That is, in the generating of a politician's sentiment regarding a topic or legislative topic, the generating of a sentiment may be derived from the statements about the particular topic or piece of legislation they have spoken about. From the variety of politician statements, the system generates one or more: corresponding emotional score generated at emotional scoring block 86A, a corresponding behavioral score generated at behavioral block 86B, a corresponding attitude score generated at attitude scoring block 86C, a corresponding tone score generated at tone scoring block 86D, and a corresponding awareness score generated at awareness scoring block 86E. Each of these scores are used to determine if a politician's sentiment 88 of a particular the topic is positive or negative. The politician's sentiment value(s) 88 (corresponding to a politician 83) is associated with the respective topic(s) and/or legislation, and stored in a memory storage device, e.g., database 89, or a like data storage device configured for storing the data politician's sentiment associated with the politician and the particular corresponding topic. This politician's sentiment score may be an overall average score based on a combination of the combined scores from scoring blocks 86A-86E. It is further noted that different blocks may have different weights assigned to them. For example a user may define behavioral as having a higher weight than the other four scoring factors. The system would then calculate a weighted average for politician's sentiment.

In one embodiment, as time progresses, the politician's sentiment values 88 are tracked, and over time, it is assessed whether a politician's sentiment values have changed. In one embodiment, a politician sentiment momentum processing block 90 is invoked at the computing system 50, e.g., periodically, to create a politician's sentiment value relating to a particular topic or piece of legislation, and over time assess whether the sentiment values 88 increases or decreases, or remains flat, indicating whether that politician's sentiment of any topic is increasing or decreasing over time, i.e., how the politician's sentiment is trending (i.e., a momentum) for a particular topic or legislation. That is, topic sentiment momentum block 90 is programmed to ascertain a trend 91, i.e., a measure or score of the politician's view of a current topic. For example, as shown in FIG. 4, each of the one or more corresponding sentiment emotional scores generated at emotional scoring block 86A, behavioral scores generated at behavioral block 86B, attitude scores generated at attitude scoring block 86C, tone score generated at tone scoring block 86D, and awareness score generated at awareness scoring block 86E are accumulated and tallied at the topic sentiment momentum processing block 90 to generate a politician sentiment momentum value 91. This momentum score may be an average of the combined individual scores from blocks 86A-86E. In one embodiment, as shown in FIG. 5, a politician sentiment momentum score 91 input to vote analytics processing block 95 may be a low value 191, medium value 192 or a high value 193 and used in predicting a likelihood that a particular piece of legislation to be voted upon will pass.

In one embodiment, the system could also output what was the most likely reason for a politician's change in sentiment, e.g., did the politician receive a large donation from an advocate group.

Returning to FIGS. 1A and 1B, in concurrent system processes, a new topic 61 from a topic source 55 may be input to a topic analytics processing block 75 for determining whether any prior or existing legislation 80 in a governmental body that has been introduced or queued up for a vote, relates to the current topic 61. In one embodiment, the topic analytics processing block 75 may receive information and data 77 representing current or recently introduced legislation 80, e.g., in the U.S., a Senate or House of Representatives bill, which information is being tracked and made publically available over a network, e.g., from a governmental website. The legislation may be of a type that may be newly introduced, or is currently up for deliberation and/or voting by a legislative body, e.g., in the U.S., Senate or House of Representatives. The information and data 77 may further relate to previous legislation that had been introduced and already voted upon by legislators.

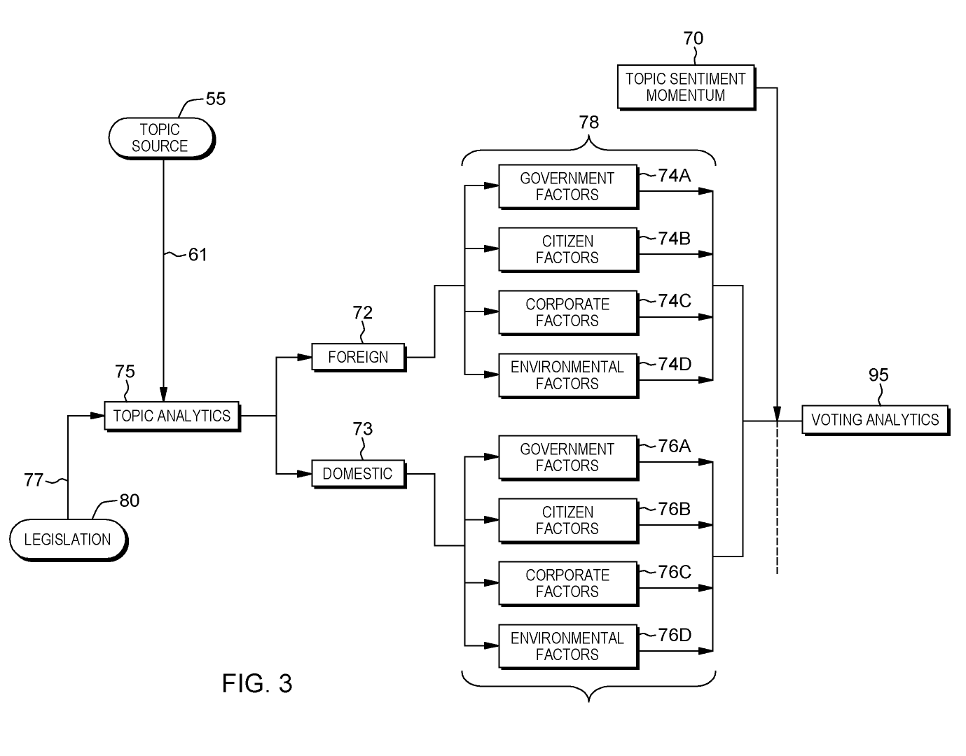

FIG. 3 presents a further block diagram depicting in greater detail the processing of the topic analytics block 75 of FIGS. 1A, 1B for analyzing a current topic. In one embodiment, the topic analytics processing block 75 runs a program of processing techniques employed on multi-processing question answering system (e.g., Watson® and IBM Bluemix®) to analyze all the words contained in a particular topic source (e.g., article or blog), and using techniques for parsing, analyzing, and drawing groupings to determine what categories or “factors” the topic most closely relates to and is about. Such groupings may be used to form a metadata of “factors” which may be then correlated with a current or new bill or piece of legislation 80. In one embodiment, topic analytics processing block 75 may thus receive a new or current topic 61 from a topic source 55 and initially, it may be determined whether the topic/topic source data is foreign or domestic, e.g., topic from a foreign originated source 72 or domestic source 73, or whether the legislation is related to a foreign or domestic concern. For a new or current topic (foreign or domestic) analytics are performed to break down the factors 78 from the topic source. For example, for a foreign originated topic 72, analytics are performed to break down the topic into various categories or “factors” 78 including, but not limited to: government factors 74A, citizen factors 74B, corporate factors 74C and environmental factors 74D; similarly, for domestic originated topic 73, analytics are performed to break down the topic into various factors, e.g., government factors 76A, citizen factors 76B, corporate factors 76C and environmental factors 76D. In embodiments, a topic sentiment may be related to one or more of these factors, and each of these factors may be weighted, according to their pertinence, in topic analytics block processing. For example, a factor relating to legislation enacted in a foreign country may be similar to the new domestic legislation, and sentiment related to a government factor may be weighted higher as this factor may indirectly impact the domestic vote for the similar legislation. As another example, there may be domestic legislation that affects foreign activity (e.g., factors).

In one embodiment, once one or more factors 78 are generated for a topic, the analytics block 75 may associate a weight for each said determined factors, and use these weighted factors to further score the (public's or politician's) topic sentiment in relation to weights assigned to these factors. Thus, in one embodiment, as shown in FIG. 5, the topic analytics performed at block 75 may further generate, based on the analytics and analyzed factors, a variety of importance weights, e.g., a weight 176 associated with an importance of a politician, a weight 177 associated with an importance of a country, and a weight 178 associated with an importance of the public. These factors may be received by the voting analytics processing block 95 for use in predicting a likelihood that a particular piece of legislation to be voted upon will pass.

In one aspect, associations are made to associate a piece of legislation with the topics/factor(s). Thus, as shown in FIG. 3, in a further embodiment, once one or more factors 78 are generated for a topic, the topic analytics block 75 may further correlate the new topic or associated topics (i.e., and factors 78 thereof) with one or more particular new pieces of legislation 80 related to that topic 61 and/or factors. The correlation may be determined by a keyword matching or natural language processing (NLP) techniques applied to the topic and prior topics or prior or current legislation, or other techniques such as voice recognition (e.g., if legislation is being read), etc. For example, for a topic 61 relating to an environmental factor that may be determined to have a large favorable public sentiment, topic analytics block 75 may find a related piece of legislation that, if enacted, will impose a regulation addressing that particular environmental factor. It is conceivable that this related piece of legislation will negatively impact an entity such as an oil company, which may require an expensive change to that entity's refining or manufacturing procedures, for example. Using the above-mentioned Watson® and IBM Bluemix® analytics tools, processing block 75 maps the selected or current topic/factors with one or more new or previous pieces of legislation 80, and further associates the topic with those politicians who may be voting on the particular piece of legislation, e.g., as determined based on a politician's statements or voting record.

In one example, processing block 75 maps the selected or current topic with one or more new or previous pieces of legislation 80, and further obtains from public records information relating to that piece of legislation 80. For example, in FIGS. 1A, 1B, the system 50 may track and store publically available voting records 81 of all politicians 83 for all types of legislation that have been voted upon, at any governmental level. The voting record includes information of each politician and their voting record: how they voted in past bills for similar legislation. From these records, it may be determined which particular legislator(s) (i.e., politician(s)) 83 wrote/sponsored/co-sponsored or voted upon a piece of legislation 80, e.g., a bill, and further indicates the bill's status in a particular legislative body (e.g., recently introduced, pending in committee, queued up for a vote, etc.) or legislative outcome (e.g., enacted (passed), failed or vetoed). The system further runs steps for identifying which legislators (e.g., a legislative body) will vote upon a particular new piece of legislation, and when a vote on a new legislation or bill is scheduled to occur. In addition to the voting record on prior legislation, other types of information that may be associated with the politician's voting record, may include a political party affiliation, and a source of funding.

In one embodiment, shown in FIGS. 1A, 1B, the legislation information 80 is tracked and data may be extracted, over time, to develop a government voting record 81 for each legislator/politician (e.g., U.S. Senator or U.S. Representative). Alternatively, the government voting records themselves may be accessed as processable data and stored in a memory storage device, e.g., a relational database 79, or a like data storage device configured for storing data relating the politician's historical voting record and the associated legislation that politician voted upon.

In a further embodiment, topic analytics processing block 75 employs methods for further correlating between any new or current legislation with previous associated legislation(s) and their corresponding legislative outcomes. For example, topic analytics processing block 75 may further employ methods to correlate a new legislation topic with one or more prior pieces of legislation 80 having already been considered and/or voted upon by the politician (of the legislative body) and stores this correlation in the politician's voting record. In one embodiment, the computing system performs the topics/legislation correlation using keyword matching, sentence matching, or natural language processing (NLP) techniques applied to the topic and prior topics or prior or current legislation, or other techniques such as voice recognition (e.g., if legislation is being read), etc. As shown in FIGS. 1A, 1B, the topic analytics block 75 may thus determine, from the government voting record 81 for a legislator (e.g., politician) 83, how a politician may vote on a new legislation, i.e., a likelihood to vote for, or a likelihood to vote against, the legislation (e.g., of a related current topic) based upon how that politician voted on prior legislations (e.g., having similar topic(s) or importance factors 78) that it correlates with. Thus, in one embodiment, as shown in FIG. 5, the topic analytics performed at block 75 may further generate, based on the analytics applied to a politician's voting record 81, how a particular politician or legislator voted on legislation related to a particular topic/factor, i.e., whether that legislator was in favor or supported the particular legislation 101, or whether that legislator was opposed to the particular legislation 102, i.e., by voting against it)

FIG. 5 depicts the various inputs to voting analytics processing block 95 used in predicting a likelihood that a particular piece of legislation to be voted upon by legislators will pass. In one embodiment, voting analytics block 95 receives the topic sentiment momentum score generated by the topic sentiment momentum generating block 70. These inputs, e.g., a low value 171, medium value 172 and high value 173 represent the sentiment of the public and at least the legislator's constituent's sentiment regarding a particular topic. Voting analytics block 95 receives the politician's sentiment momentum score generated by the politician sentiment momentum generating block 90. These inputs, e.g., a low value 191, medium value 192 and high value 193 represent the sentiment of a particular legislator (politician) regarding a particular topic/piece of legislation.

Voting analytics block 95 further receives the results of topic analysis performed at topic analytics block 75 including, in one embodiment, the factors assessed as most closely representing the topic and corresponding pieces of new or related legislation. Given an assessment of the importance of topic's various factors generated at topic analytics block 75, the voting analytics block 95 may alternately, or in addition, receive a politician's importance assessment 176, a country's importance assessment 177 (foreign or domestic), and/or the public's importance assessment 178, each representing an assessed impact of the topic or legislation as it applies to a politician, a country, or the public in general.

Voting analytics block 95 further receives the developed government voting record 81 for each legislator/politician (e.g., U.S. Senator or U.S. Representative) as it pertains to a particular piece of legislation correlated to the current topic. Data from the government voting record 81 relates the politician's historical voting record, e.g., support for 101, or support against 102 a prior associated piece of legislation that politician voted upon.

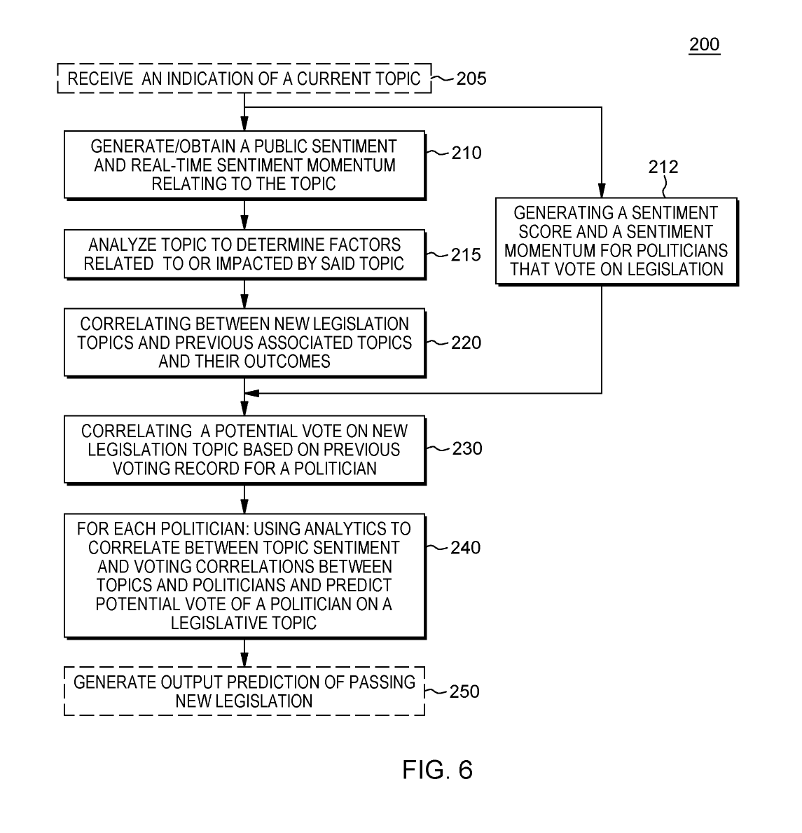

FIG. 6, in particular, depicts a processing method 200 employed by the computing system of FIGS. 1A, 1B. At 205, the computing system receives or obtains an input specifying a current topic of importance to an entity, a politician or the public at large. In one embodiment, for example, the topic received may be engendered by a politician's statement, or a new piece of legislation recently introduced by legislators. In a non-limiting, illustrative embodiment, one topic may relate to a certain chemical used by a company to manufacture a product that may be harmful to the environment. Real-time analytics are performed at 210 to obtain/generate a public sentiment score relating to the topic, e.g., analyzed based on detected emotional, behavioral, attitudinal factors exhibited by the public, for example. An instantaneous sentiment momentum score is further generated indicating whether the current sentiment is changing, and in what direction (e.g., increasing/decreasing). Further, in concurrent processes 215, the topic itself is analyzed to obtain various other factors, topics or categories (e.g., governmental, citizen, environmental) representative or related to the topic. For the example topic related to a harmful chemical, analysis may determine a factor leading to a finding that legislation has been introduced in a foreign country to ban the same chemical. Otherwise, it may be determined that another legislator has recently introduced legislation banning the same or another chemical which factor may weigh more heavily in determining a politician's sentiment.

Thus, in one embodiment, at 220, analytics are invoked to correlate this new legislation topic (e.g., harmful chemical) to prior associated topics, legislations, and their respective outcomes. For these other topics/legislations, it may be further determined which politicians voted and particularly how they voted. Associations may be drawn for similar types of legislation and how members voted such that a legislative voter track history is obtained for each legislator.

Analytics may then be invoked to correlate a potential vote on the current topic (harmful chemical) with the previous voting records of politicians in the particular legislative body that will likely vote on such new legislation. Thus, in concurrent processes, real-time analytics are performed at 212 to obtain/generate each politician's sentiment score relating to the topic, e.g., analyzed based on detected emotional, behavioral, attitudinal factors exhibited by the politician. For example, a politician may have stated an intent to introduce domestic legislation to ban the same chemical, or, in opposition, indicated banning of a chemical may provide more economic harm to a whole industry than the potential harm to the environment engendered by its use, in which case that politician may not support the ban. Then, at step 230, analytics may be performed to correlate a potential vote on a new piece of legislation already introduced or expected to be introduced based on previous voting records for that politician. Then, at step 240, analytics are employed at voting analytics block to determine with high accuracy how a politician will vote on a certain subject. These analytics correlate between the sentiment and voting correlations between topics and politicians and predict a potential vote of a politician on a legislative topic. In one embodiment, step 240 is an iterative process, such that the methods may be applied across a large population of politicians, e.g., U.S. Senate, U.S. House of Representatives, etc.—depending on the structure of the government of that country. In this embodiment, all politicians' records may be processed and assessed to determine their likelihood of voting, and using the aggregate of all politicians' predicted votes, to determine whether a particular piece of legislation, e.g., banning a chemical, would be enacted or fail. This process may include weighing and analyzing all factors at the voting analysis block to determine a most likely vote by a politician. Some factors can be may be weighted higher than others (e.g., a politician's voting record versus a topic momentum).

As further shown in FIG. 6, step 250 represents an output of the determination of the likelihood a piece of legislation concerning the topic will pass. That is, the vote analytics processing block 95 receives as input: the new and prior legislation that is being tracked, the sentiment and sentiment momentum of the public (e.g., including sentiment of constituents of all the politicians who will be voting on the new piece of legislation) regarding the topic of the new legislation, and the sentiment of the politician and that politician's voting record in the past and how influenced were/are they by the sentiment of that politician's constituents. For example, the processing block further performs a correlation of a politician's likely vote on new legislation based on the previous voting record for that politician. In one embodiment, vote analytics processing block uses analytics to correlate between sentiment and voting correlations between topics and politicians' and predict a potential vote of a politician on a legislative topic. These correlations could be done through correlation of key words, language, emotions, etc., between the politician and the topic and then correlated to what the most likely vote would be (e.g., the politician may say which way they will vote). Then, based on these inputs, the vote analytics processing block generates a likelihood that each politician will vote a certain way for the particular piece of legislation.

In one embodiment, the analytics block 95 looks at the aggregate of the votes for each politician that will be voting on the particular new piece of legislation (relating to the current topic) to output an overall probability of a likelihood of an outcome of a vote on a piece of legislation or regulation (e.g., a probabilistic outcome of a vote) and, by aggregating individual politician's votes, output an indication 98 of whether the new legislation is predicted to pass.

Thus, for the example topic of a harmful chemical, given the prediction and high likelihood that a particular piece of legislation may pass, a company may begin a process to explore other chemicals that can be used in its place, anticipating that the chemical may be banned in the future.

In general, as legislative bodies make decisions to change laws or regulations that take time, the method 200 predicts an anticipated output of an outcome based on who is voting and what is known about the legislators.

The methods further illustrate that, as a certain topic with the public picks up steam, the system is triggered to determine a politician's sentiment, i.e., determined by the analytics whether there is a resulting momentum shift. Further, depending on previous data analyzed, a politician's momentum also can be tipped towards how that politician may respond based on previously analyzed data. These two momentums can then be fed into the vote analytics block 95. As a third piece of analytics before a final vote analytics is run, the politician's current record, party affiliation, source of funding, and voting record on prior legislation may be analyzed to further drive a higher percent accuracy of the voting analytics.

If, for example, a Congressman/politician votes a certain way, based on the sentiment (e.g., if sentiment is building) there may be predicted that the piece of legislation or regulation will pass, e.g., a Congressman/politician may change his/her voting behavior based on the current sentiment captured in the system.

In response to an output 98, an entity may be immediately notified and be able to understand what law/regulations may change the impact that affects the entity's ability to do business.

The system thus enables a business entity to adapt early to a new law or regulation and determine a replacement solution. That business may then sell a replacement solution to other businesses who are running out of time to comply with a new law or regulation.

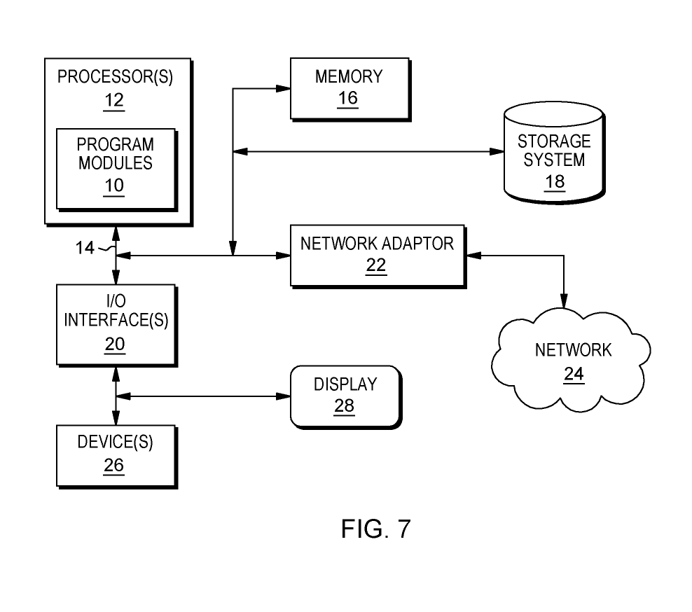

FIG. 7 illustrates an example computing system in accordance with the present invention. It is to be understood that the computer system depicted is only one example of a suitable processing system and is not intended to suggest any limitation as to the scope of use or functionality of embodiments of the present invention. For example, the system shown may be operational with numerous other general-purpose or special-purpose computing system environments or configurations. Examples of well-known computing systems, environments, and/or configurations that may be suitable for use with the system shown in FIG. 7 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

In some embodiments, the computer system may be described in the general context of computer system executable instructions, embodied as program modules stored in memory 16, being executed by the computer system. Generally, program modules may include routines, programs, objects, components, logic, data structures, and so on that perform particular tasks and/or implement particular input data and/or data types in accordance with the present invention (see e.g., FIG. 5).

The components of the computer system may include, but are not limited to, one or more processors or processing units 12, a memory 16, and a bus 14 that operably couples various system components, including memory 16 to processor 12. In some embodiments, the processor 12 may execute one or more modules 10 that are loaded from memory 16, where the program module(s) embody software (program instructions) that cause the processor to perform one or more method embodiments of the present invention. In some embodiments, module 10 may be programmed into the integrated circuits of the processor 12, loaded from memory 16, storage device 18, network 24 and/or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer system may include a variety of computer system readable media. Such media may be any available media that is accessible by computer system, and it may include both volatile and non-volatile media, removable and non-removable media.

Memory 16 (sometimes referred to as system memory) can include computer readable media in the form of volatile memory, such as random access memory (RAM), cache memory an/or other forms. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

The computer system may also communicate with one or more external devices 26 such as a keyboard, a pointing device, a display 28, etc.; one or more devices that enable a user to interact with the computer system; and/or any devices (e.g., network card, modem, etc.) that enable the computer system to communicate with one or more other computing devices. Such communication can occur via Input/Output (I/O) interfaces 20.

Still yet, the computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with the computer system. Examples include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method for triggering compliance with a law or legislation comprising:
determining, at the processing unit, a public sentiment associated with a current topic of public discourse and generating an associated public momentum score;
determining, at the processing unit, any new law or new legislation pending enactment in a legislative body that relates to the current topic, said law or legislation having provisions determined to change an operation of an entity;
identifying, at the processing unit, each legislator to vote on the new law or new legislation pending enactment;
determining, at the processing unit, for each identified legislator, a sentiment and a legislator sentiment momentum score of said current topic;
obtaining data representing a legislator's voting history relating to one or more previous legislations relating to said current topic;
determining, at the processing unit, for each identified legislator, a probability measure indicating that likely legislator's vote on said new law or new legislation using that legislator's sentiment momentum score, and that legislator's voting history relating to said one or more previous legislations and the public sentiment momentum score;
determining, at the processing unit, a probability of enactment of said new law or new legislation based on the determined probability measure; and
generating, by the processing unit, an output signal to notify an entity of said probability of enactment.

2. The method of claim 1, further comprising:
correlating, at the processing unit, said determined new law or new legislation with one or more previous legislations associated with the current topic and already voted upon by legislators.

3. The method of claim 1, wherein said determining a public sentiment comprises:
periodically monitoring topic sources for information relating to a current topic of public discourse, said topic sources selected from a group comprising: a web-site, a web-blog, a newsfeed, a public Internet, a source of public opinions.

4. The method of claim 1, wherein said determining a legislator's sentiment comprises:
periodically monitoring a source of legislator opinions relating to a current topic of public discourse, law or legislation, said source of legislator opinions selected from a group comprising:
a web-site, a web-blog, a newsfeed, a public Internet.

5. The method of claim 3, wherein said periodically monitoring said topic sources for information comprises:
monitoring said topic sources for information relating to one or more of: a public emotion, behavior, and attitude towards said current topic, a tone of public statements relating to said current topic, and a public awareness relating to said current topic, and processing said topic relating monitored information to generate said public sentiment score.

6. The method of claim 4, wherein said periodically monitoring said source of legislator opinions for information comprises:
monitoring said source of legislator opinions for information relating to one or more of: a legislator's emotion, behavior, and attitude towards said current topic, a tone of legislator statements relating to said current topic, and a legislator awareness of said current topic, and processing said topic relating monitored information to generate said legislator sentiment score.

7. The method of claim 2, further comprising:
determining factors related to said current topic, said factors comprising one or more of: a government, a country's citizens, a corporation, or environment of a country in which said entity resides, or relates to factors impacting the government, citizens, corporations, or environment of a foreign country,
associating weights for said determined factors; and
using said associated weights to modify said public sentiment momentum score or a legislator sentiment momentum score.

8. A system for triggering compliance with a law or legislation comprising:
a processing unit;
a memory coupled to the processing unit, wherein the memory stores program instructions which, when executed by the processing unit, cause the processing unit to:
determine a public sentiment associated with a current topic of public discourse and generating an associated public momentum score;
determine any new law or new legislation pending enactment in a legislative body that relates to the current topic, said law or legislation having provisions determined to change an operation of an entity;
identify each legislator to vote on the new law or new legislation pending enactment;
determine, for each identified legislator, a sentiment and a legislator sentiment momentum score of said current topic;
obtain data representing a legislator's voting history relating to one or more previous legislations relating to said current topic;
determine for each identified legislator, a probability measure indicating that likely legislator's vote on said new law or new legislation using that legislator's sentiment momentum score, and that legislator's voting history relating to said one or more previous legislations and the public sentiment momentum score;
determine a probability of enactment of said new law or new legislation based on determined probability measures; and
generate an output signal to notify an entity of said probability of enactment.

9. The system of claim 8, wherein the program instructions, when executed by the processing unit, further cause the processing unit to:
correlate said determined new law or new legislation with one or more previous legislations associated with the current topic and already voted upon by legislators.

10. The system of claim 8, wherein to determine a public sentiment, the program instructions, when executed by the processing unit, further cause the processing unit to:
periodically monitor topic sources for information relating to a current topic of public discourse, said topic source selected from a group comprising: a web-site, a web-blog, a newsfeed, a public Internet, a source of public opinions.

11. The system of claim 8, wherein to determine a legislator's sentiment, the program instructions, when executed by the processing unit, further cause the processing unit to:
periodically monitor a source of legislator opinions relating to a current topic of public discourse, law or legislation, said source of legislator opinions selected from a group comprising: a web-site, a web-blog, a newsfeed, a public Internet.

12. The system of claim 10, wherein to periodically monitor said topic source for information, the program instructions, when executed by the processing unit, further cause the processing unit to:
monitor said topic sources for information relating to one or more of: a public emotion, behavior, and attitude towards said current topic, a tone of public statements relating to said current topic, and a public awareness relating to said current topic, and processing said topic relating monitored information to generate said public sentiment score.

13. The system of claim 11, wherein to periodically monitor said source of legislator opinions for information, the program instructions, when executed by the processing unit, further cause the processing unit to:
monitor said source of legislator opinions for information relating to one or more of: a legislator's emotion, behavior, and attitude towards said current topic, a tone of legislator statements relating to said current topic, and a legislator awareness of said current topic, and
process said topic relating monitored information to generate said legislator sentiment score.

14. The system of claim 9, wherein the program instructions, when executed by the processing unit, further cause the processing unit to:
determine factors related to said current topic, said factors comprising one or more of: a government, a country's citizens, a corporation, or environment of a country in which said entity resides, or relates to factors impacting the government, citizens, corporations, or environment of a foreign country,
associate weights for said determined factors; and
use said associated weights to modify said public sentiment momentum score or a legislator sentiment momentum score.

15. A computer program product comprising a computer-readable storage medium having a computer-readable program stored therein, wherein the computer-readable program, when executed on a computing device including at least one processing unit, causes the at least one processing unit to:
determine a public sentiment associated with a current topic of public discourse and generating an associated public momentum score;
determine any new law or new legislation pending enactment in a legislative body that relates to the current topic, said law or legislation having provisions determined to change an operation of an entity;
identify each legislator to vote on the new law or new legislation pending enactment;
determine, for each identified legislator, a sentiment and a legislator sentiment momentum score of said current topic;
obtain data representing a legislator's voting history relating to one or more previous legislations relating to said current topic;
determine for each identified legislator, a probability measure indicating that likely legislator's vote on said new law or new legislation using that legislator's sentiment momentum score, and that legislator's voting history relating to said one or more previous legislations and the public sentiment momentum score;
determine a probability of enactment of said new law or new legislation based on determined probability measures; and
generate an output signal to notify an entity of said probability of enactment.

16. The computer program product of claim 15, wherein said computer-readable program configures said at least one processing unit to:
correlate said determined new law or new legislation with one or more previous legislations associated with the current topic and already voted upon by legislators.

17. The computer program product of claim 15, wherein to determine a public sentiment, the computer-readable program configures said at least one processing unit to:
periodically monitor a topic source for information relating to a current topic of public discourse, said topic sources are selected from a group comprising: a web-site, a web-blog, a newsfeed, a public Internet, a source of public opinions; and
to determine a legislator's sentiment, said computer-readable program configures said at least one processing unit to:
periodically monitor a source of legislator opinions relating to a current topic of public discourse, law or legislation, said source of legislator opinions selected from a group comprising: a web-site, a web-blog, a newsfeed, a public Internet.

18. The computer program product of claim 17, wherein to periodically monitor said topic source for information, the computer-readable program configures said at least one processing unit to:
monitor said topic source for information relating to one or more of: a public emotion, behavior, and attitude towards said current topic, a tone of public statements relating to said current topic, and a public awareness relating to said current topic, and process said topic relating monitored information to generate said public sentiment score.

19. The computer program product of claim 17, wherein to periodically monitor said source of legislator opinions for information, the computer-readable program configures said at least one processing unit to:
monitor said source of legislator opinions for information relating to one or more of: a legislator's emotion, behavior, and attitude towards said current topic, a tone of legislator statements relating to said current topic, and a legislator awareness of said current topic, and
process said topic relating monitored information to generate said legislator sentiment score.

20. The computer program product of claim 16, wherein the computer-readable program configures said at least one processing unit to:
determine factors related to said current topic, said factors comprising one or more of: a government, a country's citizens, a corporation, or environment of a country in which said entity resides, or relates to factors impacting the government, citizens, corporations, or environment of a foreign country,
associate weights for said determined factors; and
use said associated weights to modify said public sentiment momentum score or a legislator sentiment momentum score.
